(19) United States
(12) Patent Application Publication
(10) Pub. No.: US 2007/0239906 A1
(43) Pub. Date: Oct. 11, 2007

(54) Input/output agent having multiple secondary ports

(76) Inventors: Kersi H. Vakil, Olympia, WA (US); Abhimanyu Kolla, Tacoma, WA (US)

Correspondence Address: INTEL CORPORATION;c/o INTELLEVATE, LLC, P.O. BOX 52050, MINNEAPOLIS, MN, 55402, US

(21) Appl. No.: 11/375,498

(22) Filed: Mar. 13, 2006

(51) Int. Cl. G06F 5/00

(52) U.S. Cl. 710/52

(57) ABSTRACT

Embodiments of the invention are generally directed to systems, methods, and apparatuses for an input/output agent having multiple secondary ports. In some embodiments, the input/output agent includes a primary port to communicate data with an upstream agent over a serial point-to-point interconnect. The input/output agent may also include M secondary ports to communicate data with a corresponding M downstream agents, wherein downstream data is forwarded from the primary port to at least one of the M secondary ports.

### TECHNICAL FIELD

Embodiments of the invention generally relate to the field of integrated circuits and, more particularly, to systems, methods and apparatuses for an input/output agent having multiple secondary ports.

### BACKGROUND

Conventional memory systems typically use a multi-drop memory topology such as a conventional double data rate (DDR) memory bus. In multi-drop memory topologies each component in a memory subsystem is coupled with the same memory bus. In general, the signaling speed of the multi-drop memory bus is constrained by the signal integrity limitations of the bus (e.g., the DDR bus).

Point-to-point memory topologies can be used to provide relatively high signaling speeds. One example of a point-to-point memory technology is the fully-buffered dual inline memory module (FBD) technology. FBD technology uses a buffer to isolate commodity dynamic random access memory devices (DRAMs) from a serial point-to-point memory channel. The point-to-point memory channel may include a number of DIMMs daisy chained together by the point-to-point memory channel.

The access latency of a FBD memory channel is constrained by the latency associated with the DIMM that is most distant from the memory controller. Thus, as capacity increases (e.g., as DIMMs are added to the memory system), access latency continues to increase. This proportional relationship between capacity and access latency compels system designers to choose between having substantial capacity or low access latency.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram illustrating selected aspects of a serial input/output agent, implemented according to an embodiment of the invention.

FIG. 2 is a block diagram illustrating selected aspects of a fully-buffered dual inline memory module (FBD) system, implemented according to an embodiment of the invention.

FIG. 3 is a block diagram illustrating selected aspects of a backwards compatible system having a number of serial input/output agents, implemented according to an embodiment of the invention.

FIG. 4 is a block diagram illustrating selected aspects of a cost effective architecture for boosting memory capacity according to an embodiment of the invention.

FIG. 5 is a block diagram illustrating selected aspects of a multi-processor system, implemented according to an embodiment of the invention.

FIG. 6 is a block diagram illustrating selected aspects of networked serial input/output agents, according to an embodiment of the invention.

FIG. 7 is a block diagram illustrating selected aspects of multiplexed and de-multiplexed reads and writes, according to an embodiment of the invention.

FIG. 8 is a block diagram illustrating selected aspects of an electronic system, according to an embodiment of the invention.

FIG. 9 is a block diagram illustrating selected aspects of an electronic system, according to an alternative embodiment of the invention.

### DETAILED DESCRIPTION

Embodiments of the invention are generally directed to systems, methods, and apparatuses for an input/output agent having multiple secondary ports. A “serial input/output (I/O) agent” refers to a device that receives data from a serial point-to-point interconnect and, if the data is addressed to another agent, is capable of forwarding the data to a downstream agent. The advanced memory buffer (AMB) used in FBD memory systems is one example of a serial I/O agent. In some embodiments, a serial I/O agent includes a primary port and two or more secondary ports. The primary port communicates (e.g., receives and/or transmits) data with an upstream agent (e.g., a memory controller or an upstream DIMM). Each secondary port communicates data with a downstream agent (e.g., a downstream DIMM). As is further described below, a serial I/O agent having multiple secondary ports may provide a number of advantages such as reduced access latency and/or reduced power consumption.

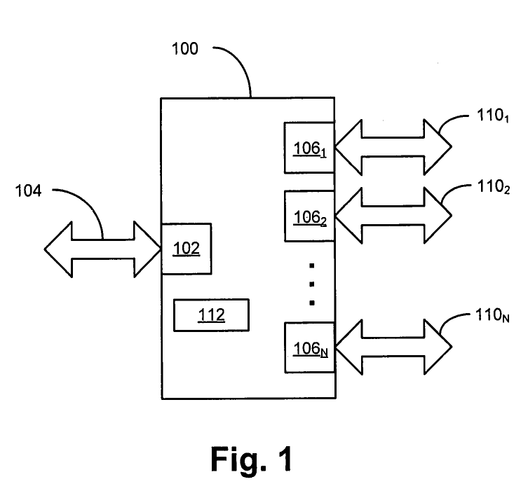

FIG. 1 is a block diagram illustrating selected aspects of a serial input/output (I/O) agent, implemented according to an embodiment of the invention. The term “agent” broadly refers to an integrated circuit or a portion of an integrated circuit. A serial I/O agent refers to an agent that communicates with other agents over serial point-to-point interconnects and that forwards data from upstream agents to downstream agents. The serial I/O agent 100 includes a primary port 102 and N secondary ports 106. The primary port 102 communicates data with an upstream agent. The term “upstream” refers to the direction in which the requesting agent (e.g., a processor, a memory controller, etc.) resides. The upstream agent may reside on the same IC as the serial I/O agent 102 or it may reside on a separate IC. The serial I/O agent 100 also includes forwarding logic 112 to forward data between the primary port 102 and the N secondary ports 106.

The primary port 102 exchanges data with the upstream agent via a serial point-to-point interconnect 104. The serial point-to-point interconnect 104 may include a number of bit-lanes over which data (e.g., memory data, commands, addresses, etc.) is serially communicated (e.g., transmitted and/or received). A “point-to-point interconnect” refers to an interconnect that is composed of direct links between agents. In some embodiments, the serial point-to-point interconnect 104 is an FBD memory channel. In alternative embodiments, the serial point-to-point interconnect is based on a different technology such as peripheral component interconnect (PCI) Express, redundant array of inexpensive disks (RAID), serial advanced technology attachment (SATA), and the like.

The secondary ports 106 communicate data with a corresponding number of downstream agents. The term “downstream” refers to a direction that is away from the requesting agent (e.g., southbound, next memory device in the chain). Each secondary port 106 may communicate with a downstream agent over a serial point-to-point interconnect 110. In some embodiments, the serial point-to-point interconnects are links in a FBD memory channel. As is further described below, a system having serial I/O agents with multiple secondary ports 106 may exhibit lower latency and/or lower power consumption in comparison to conventional systems.

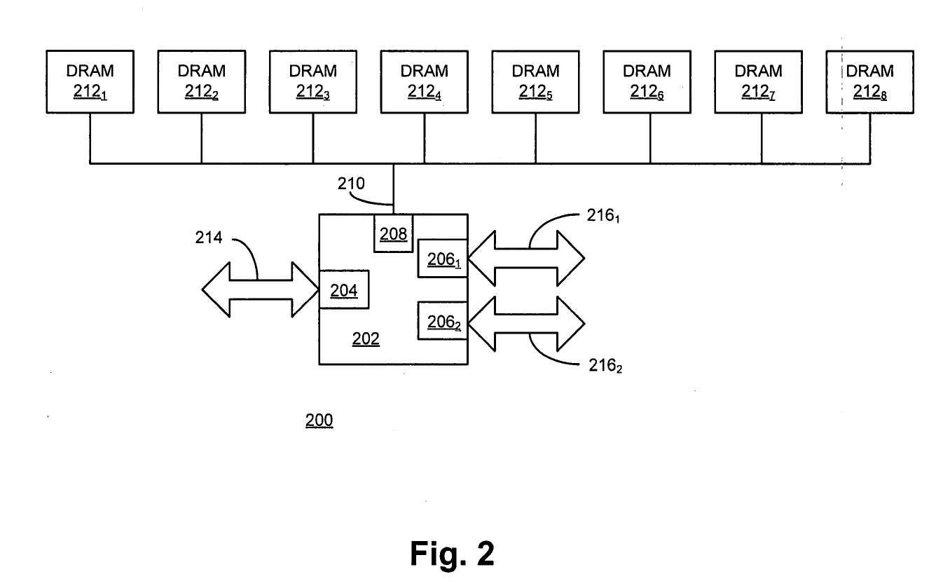

FIG. 2 is a block diagram illustrating selected aspects of a memory system based on FBD technology that is implemented according to an embodiment of the invention. This FBD-N system 200 includes an advanced memory buffer (AMB) 202 (e.g., a serial I/O agent) and DRAM devices 212. The term FBD-N refers to an FBD system in which at least one I/O agent (e.g., an AMB) has multiple secondary ports. For ease of description, the illustrated embodiment shows eight DRAM devices 212. It is to be appreciated that, in alternative embodiments, there may be more or fewer DRAM devices 212. Multi-drop bus 210 couples DRAMs 212 with AMB 202. In some embodiments, multi-drop bus 210 is based, at least in part, on the double data rate parallel, low speed (DDR) interface.

AMB 202 includes a primary port 204, two secondary ports 206, and a DDR port 208. The Primary port 204 communicates data (e.g., read/write data, commands, addresses) with an upstream agent over the FBD interconnect 214. The upstream agent may be, for example, a memory controller or an upstream DIMM. The memory controller may be integrated on the same die as a processor or it may be located on a separate integrated circuit. If the data received on the primary port 204 is addressed to a downstream DIMM, then the primary port 204 forwards the data to (at least) one of the secondary ports 206.

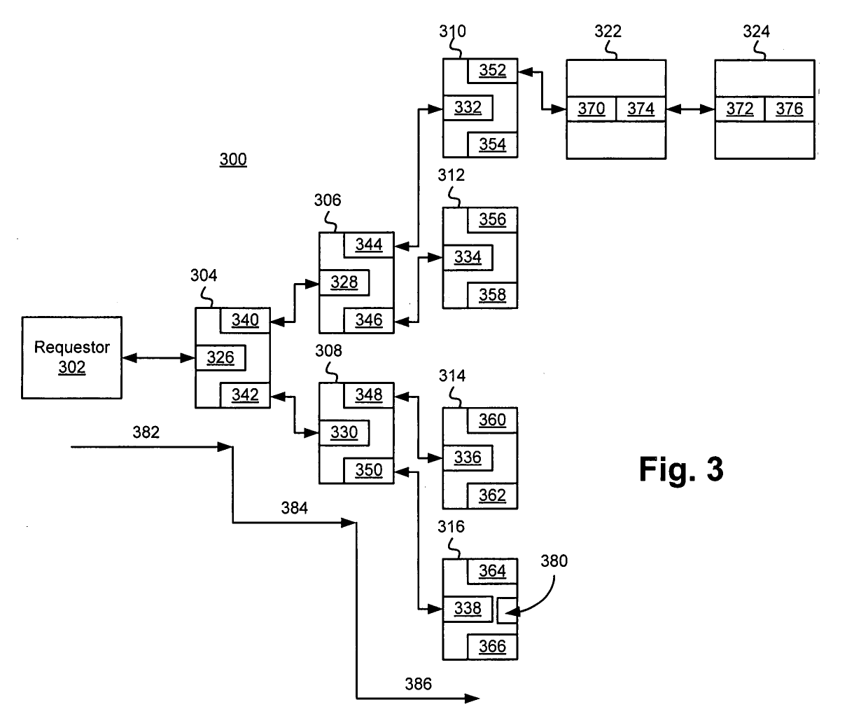

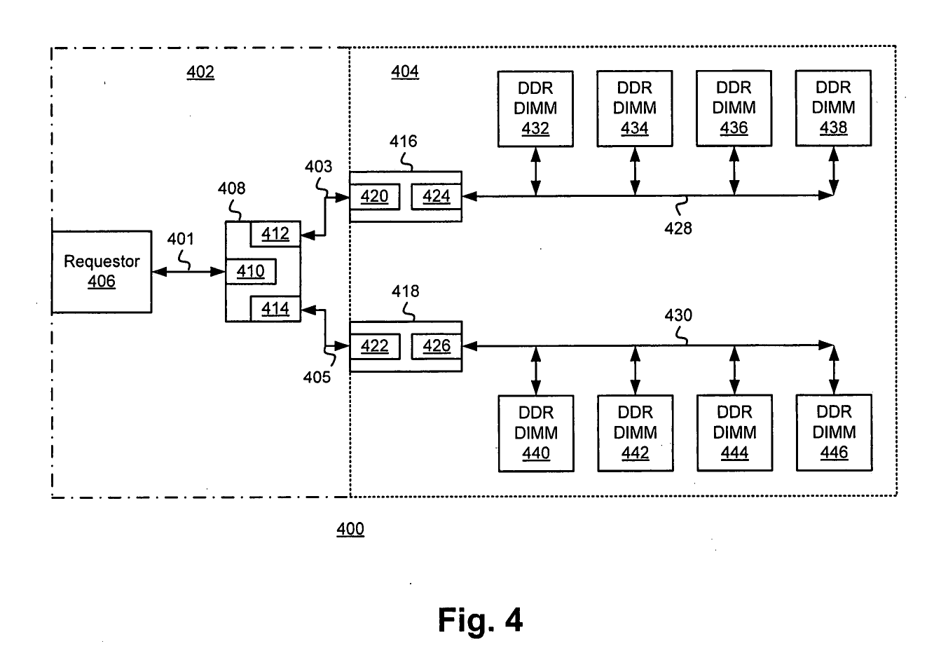

The secondary ports 206 communicate data with one or more downstream DIMMs via FBD interconnects 216. More particularly, the secondary ports 206 communicate data with corresponding primary ports on the AMBs of downstream DIMMs. For the purposes of illustration, FIG. 2 shows two secondary ports 206. It is to be appreciated, however, that embodiments of the invention may have more than two secondary ports 206. In general, the number of secondary ports 206 may be influenced by factors such as cost, capacity, and latency. The capacity and latency advantages provided by multiple secondary ports are further discussed below with reference to FIGS. 3 and 4.

FIG. 3 is a block diagram illustrating selected aspects of a system having a number of serial input/output agents, implemented according to an embodiment of the invention. System 300 includes a requestor 302, a number of serial I/O agents having multiple secondary ports 304-316, and two conventional serial I/O agents 322-324. The requestor 302 may be any agent that requests access to a component of system 300. For example, requestor 302 may be a processor, a memory controller (e.g., for “internal” operations such as memory scrubs), an I/O device, and the like.

In the illustrated embodiment, some of the serial I/O agents 304-316 include multiple secondary ports 340-366. This enables system 300 to have a hierarchical tree topology rather than the daisy chain topology used in conventional serial I/O systems. The hierarchical tree topology provides a number of benefits over a conventional daisy chain topology. These benefits include a decrease in latency and an increase in mean-time-between-failures (MTBF).

In conventional serial I/O systems, latency is dictated by the round-trip access time to the last serial I/O agent (e.g., to the last DIMM). All of the other serial I/O agents in the conventional serial I/O system adjust their latencies to match the latency of the last serial I/O agent so that the latencies appear uniformly synchronous to a controller (e.g., a memory controller). Thus, in a conventional system having seven serial I/O agents, the latency of the system would be dictated by the round-trip access time to the seventh agent.

The illustrated serial I/O system 300 exhibits an improvement in latency in comparison to conventional serial I/O systems. Consider, for example, the latency associated with accessing a memory location 380 in the seventh agent 316 of the illustrated system 300. A read/write message sent to the seventh agent 316 need only pass through three agents (e.g., 304, 308, and 316). In general, the latency associated with the hierarchical tree topology of the illustrated system 300 is substantially (e.g., +/−10%) proportional to log_{M}(N) where M is the number of secondary ports per agent and N is the number of agents. Thus, in general, the latency of the system 300 is inversely proportional to number of secondary ports per agent.

FIG. 3 also illustrates that the serial I/O system 300 may include both serial I/O agents having multiple secondary ports and conventional serial I/O agents (e.g., having a single secondary port). For example, the illustrated system 300 includes seven serial I/O agents having multiple secondary ports (304-316) and two conventional serial I/O agents (322-324). The conventional serial I/O agents 322-324 are coupled (in a daisy chain) with a secondary port 352 of serial I/O agent 310. Since the illustrated system 300 uses both kinds of serial I/O agents it can provide a flexible balance between performance and cost. That is, the performance advantages provided by agents 304-316 can be balanced against the possible price advantage of an older technology such as agents 322-324.

FIG. 4 is a block diagram illustrating selected aspects of an embodiment of the invention in which a system board includes a first partition to support a high speed I/O interface and a second partition to support a lower speed (and less expensive) memory I/O interface. The illustrated system 400 includes a first partition 402 and a second partition 404. The first partition 402 includes a requestor 406 and a serial I/O agent having multiple secondary ports 408. In some embodiments, links 401, 403, and 405 are high speed serial I/O links (e.g., FBD links). In such embodiments, the first partition 402 may be constructed out of low loss dielectric materials to reduce signal degradation. In addition, the first partition 402 may tightly adhere to signal routing constraints to provide an appropriate level of signal integrity.

In some embodiments, the second partition 404 supports a lower speed memory I/O interface such as the DDR memory I/O interface. This allows the second partition 404 to be constructed out of less expensive materials (e.g., FR-4) and to accommodate denser signal routing. In the illustrated embodiment, the second partition 404 includes DDR DIMMs 432-438 and 440-446 respectively coupled to DDR buses 428 and 430. In some embodiments, the first partition 402 is implemented on a first circuit board (e.g., a motherboard) and the second partition 404 is implemented on a second circuit board (e.g., a riser card). In alternative embodiments, the first partition 402 and the second partition 404 are implemented on the same circuit board.

As shown in FIG. 4, two serial I/O agents 416, 418 bridge the first partition 402 to the second partition 404. For example, the serial I/O agents 416, 418 may convert the high speed I/O signals of the first partition 402 to the lower speed DDR signals of the second partition 404. In the illustrated embodiments, the serial I/O agents 416, 418 include primary ports 420,422 and DDR ports 424, 426. The serial I/O agents 416, 418 may be conventional serial I/O agents or they may have multiple secondary ports. In some embodiments, the serial I/O agents 416, 418 are FBD advanced memory buffers (AMBs).

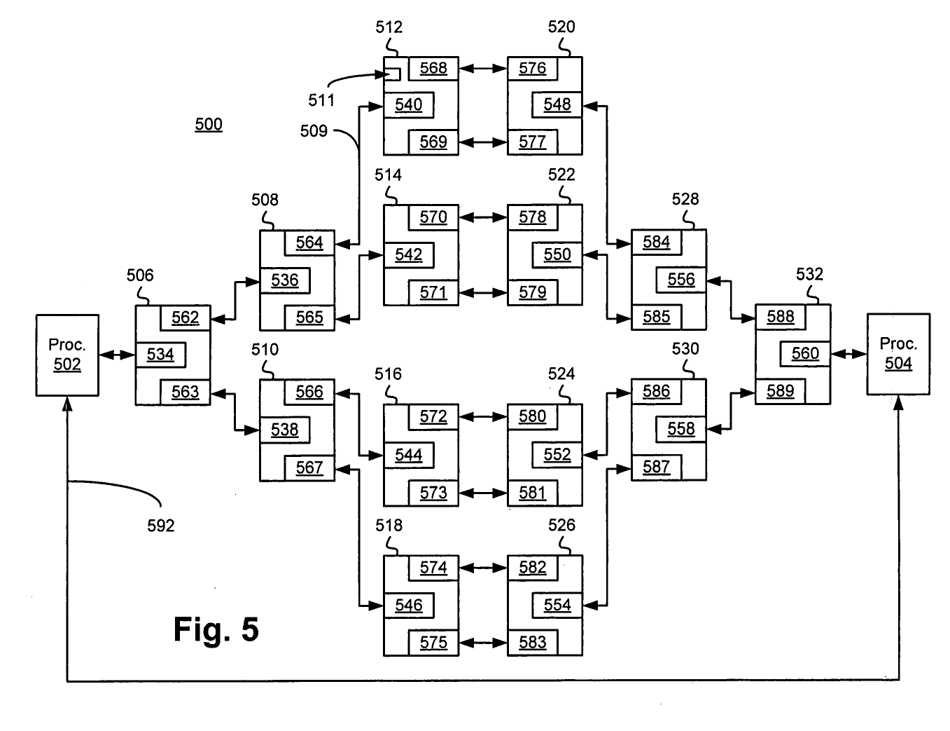

FIG. 5 is a block diagram illustrating selected aspects of a multi-processor system implemented according to an embodiment of the invention. The illustrated system 500 includes processors 502 and 504 coupled together by a communication channel 592. The processors 502, 504 may include any number of processing cores or may include any number of separate processors. The communication channel 592 may be a front side bus, a back side bus, a proprietary communication channel, a cache coherent interconnect or any other communication channel suitable for exchanging information between the processors 502, 504.

The illustrated system 500 also includes a number of advanced memory buffers (or other serial I/O agents) 506-532 each having a primary port 534-560 and multiple secondary ports 562-589. The advanced memory buffers 506-532 are organized into a memory mesh in which memory locations can be accessed through multiple paths. The advanced memory buffers 506-532 enable the illustrated system 500 to, for example, support deep reads/writes and/or provide an enhanced level of redundancy.

The term “deep read/write” refers to reading/writing to a memory location that is relatively deep (e.g., closer to the other processor) within the memory hierarchy. In some embodiments, either processor can determine whether a memory location is closer (e.g., in terms of the number of agents through which an access request would pass) to the other processor. If it is, then the initiating processor can route the access request to the other processor. The other processor may then complete the access request and, if needed, return the result to the initiating processor. This enables the illustrated system 500 to reduce the number of agents (e.g., AMBs) through which an access request travels and can, therefore, reduce the latency of the access request.

The ability to route access requests between processors over the communication channel 592 enhances the redundancy of the illustrated system 500. Consider, for example, a case in which link 509 fails. If link 509 fails, then processor 502 cannot directly reach memory location 511. In some embodiments, however, processor 502 can route an access request for memory location 511 to processor 504 over the communication channel 592. Processor 504 may then complete the access request and return the result, if any, to processor 502. It is to be appreciated that a wide array of electrical faults can be overcome by routing access requests over the communication channel 592 to avoid the fault.

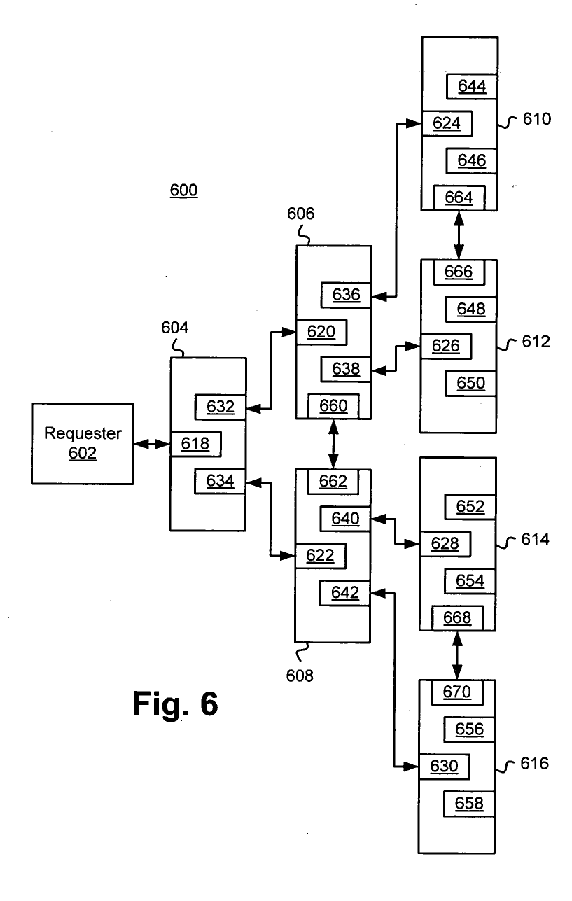

FIG. 6 is a block diagram illustrating selected aspects of networked serial input/output agents, according to an embodiment of the invention. The illustrated system 600 includes a requestor 602 and a number of serial I/O agents 604-616 that are organized into a hierarchical tree topology. Each serial I/O agents 604-616 includes a primary port 618-630 and multiple secondary ports 632-658.

In some embodiments, at least some of the serial I/O agents 604-616 include one or more tertiary ports 660-670. The term “tertiary port” refers to a port that communicates with another tertiary port of an agent that is at the same hierarchical level in the tree. For example, serial I/O agents 606 and 608 are at the same hierarchical level and they each include a tertiary port 660, 662 to communicate with each other. Similarly, serial I/O agents 610 and 612 are at the same hierarchical level and they each include a tertiary port 664, 666 to communicate with each other. The tertiary ports may be implemented with the same high speed serial I/O interface as the primary and secondary ports or they may be implemented using a lower speed and/or a narrower interface.

The purpose of the tertiary port is to enable agents that are at the same hierarchical level to communicate with each other. In some embodiments, this ability can provide a number of advantages. For example, the communication among agents at the same hierarchical level (or “lateral stream” communication) may enable these agents to establish a routing table to determine the “costs” associated with routing messages to a particular locations (e.g., memory locations). The lateral stream communication also enhances the redundancy of the system 600 because it provides multiple paths to particular locations (e.g., memory locations).

In some embodiments, the lateral stream communication enhances the reliability, availability, and serviceability (RAS) of the system 600. Consider, for example, an embodiment in which the system 600 is a memory system and the serial I/O agents 604-616 are AMBs. In such an embodiment, the lateral stream communication may be used to support data mirroring among parts of the system 600 without routing the data through a processor (e.g., requestor 602). For example, tertiary ports 660, 662 may be used to convey data and other messages between a first branch including AMBs 606-612 and a second branch including AMBs 608-616. The data stored in the second branch may be used to mirror the first branch and the data can be routed through AMBs without going through a processor. It is to be appreciated that, in some embodiments, the lateral stream communication can be used to support other RAS mechanisms.

In the systems described above, a requestor can request access to a particular location (e.g., a particular memory location) in a system. In alternative embodiments, the data sent/read to/from the serial I/O agents is progressively split (or combined) as it propagates through a hierarchical tree of serial I/O agents. These read/writes are referred to as multiplexed and de-multiplexed reads and writes because the hierarchical tree splits and combines the data as necessary.

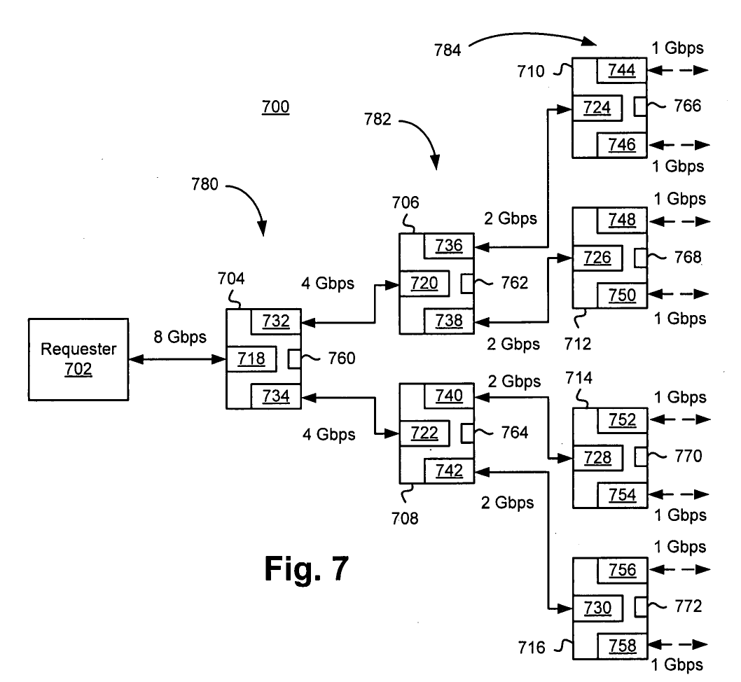

FIG. 7 is a block diagram illustrating selected aspects of multiplexed and de-multiplexed reads and writes, according to an embodiment of the invention. The illustrated system 700 includes three tiers 780-784 of serial I/O agents 704-716. Each serial I/O agent 704-716 includes a primary port 718-730 and two secondary ports 732-758. Each serial I/O agent 704-716 may receive data at its primary port 718-730, divide that data into two parts (de-multiplex), and forward both parts of the data concurrently from its secondary ports 732-758. The process may be reversed for data arriving on the serial I/O agent's secondary ports. That is, the data may arrive concurrently on the secondary ports, be added together (or multiplexed), and then forwarded from the primary port. In alternative embodiments, the serial I/O agents 704-716 may include more than two secondary ports.

In the illustrated embodiment, the speed of the secondary ports 732-758 is one-half of the speed of the primary ports 718-730. For example, serial I/O agent 704 includes a primary port 718 that operates at 8 gigabits per second (Gbps) and two secondary ports 732, 734 that each operate at 4 Gbps. Similarly, at the next tier in the tree (e.g., tier 782) the primary ports 720, 722 operate at 4 Gbps and the secondary ports 736-742 operate at 2 Gbps. The frequency scaling shown in FIG. 7 is merely one example of frequency scaling according to an embodiment of the invention. More generally, if each serial I/O agent has M secondary ports, then the speed of the secondary ports may be 1/Mth the speed of the primary port. The net effective bandwidth of the channel remains the same, however, because the data is being read/written in parallel.

In some embodiments, data is progressively de-multiplexed as it moves from the base of the tree to its branches (e.g., during a write operation). Similarly, data is progressively multiplexed as it moves from the branches of the tree to its root (e.g., during a read operation). For example, in the write (or downstream) direction, tier 780 de-multiplexes data into two elements, tier 782 further de-multiplexes the two elements into four elements, and tier 784 de-multiplexes the four elements into eight elements. Similarly, in the read (or upstream) direction, tier 784 multiplexes eight data elements into four elements, tier 782 multiplexes the four elements into two elements, and tier 780 multiplexes the two elements into one data element. In alternative embodiments, each tier may multiplex/de-multiplex the data into more elements.

In some embodiments, software (not shown) such as an operating system manages the memory address assignments for the data that is multiplexed and de-multiplexed by system 700. In addition, each agent 704-716 may include link/protocol layer logic 760-772 to support the multiplexing/de-multiplexing capability of the agent. In some embodiments, the multiplexing/de-multiplexing capability is transparent to the requestor 702.

The multiplexing and de-multiplexing capabilities of the illustrated system 700 provides a number of advantages. The total power dissipated by the system 700 is reduced because the link speed progressively decreases in the downstream (or southbound) direction. The illustrated system 700 also supports the longevity of agents because faster (and presumably newer) agents can be used to populate the portions of the system that are operating at a higher speed. Similarly, slower (and presumably older) agents can be used to populate the portions of the system that are operating at a lower speed. In addition, the system can be implemented at a reduced cost because slower and presumably less expensive agents can be used to populate portions of the system without reducing the net effective bandwidth of the system.

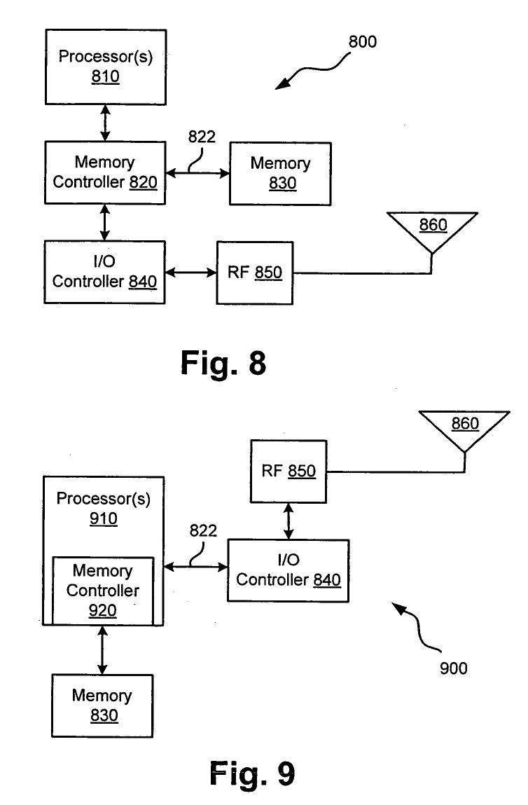

FIG. 8 is a block diagram illustrating selected aspects of an electronic system according to an embodiment of the invention. Electronic system 800 includes processor 810, memory controller 820, memory 830, input/output (I/O) controller 840, radio frequency (RF) circuits 850, and antenna 860. In operation, system 800 sends and receives signals using antenna 860, and these signals are processed by the various elements shown in FIG. 8. Antenna 860 may be a directional antenna or an omni-directional antenna. As used herein, the term omni-directional antenna refers to any antenna having a substantially uniform pattern in at least one plane. For example, in some embodiments, antenna 860 may be an omni-directional antenna such as a dipole antenna or a quarter wave antenna. Also, for example, in some embodiments, antenna 860 may be a directional antenna such as a parabolic dish antenna, a patch antenna, or a Yagi antenna. In some embodiments, antenna 860 may include multiple physical antennas.

Radio frequency circuit 850 communicates with antenna 860 and I/O controller 840. In some embodiments, RF circuit 850 includes a physical interface (PHY) corresponding to a communication protocol. For example, RF circuit 550 may include modulators, demodulators, mixers, frequency synthesizers, low noise amplifiers, power amplifiers, and the like. In some embodiments, RF circuit 850 may include a heterodyne receiver, and in other embodiments, RF circuit 850 may include a direct conversion receiver. For example, in embodiments with multiple antennas 860, each antenna may be coupled to a corresponding receiver. In operation, RF circuit 850 receives communications signals from antenna 860 and provides analog or digital signals to I/O controller 840. Further, I/O controller 840 may provide signals to RF circuit 850, which operates on the signals and then transmits them to antenna 860.

Processor(s) 810 may be any type of processing device. For example, processor 810 may be a microprocessor, a microcontroller, or the like. Further, processor 810 may include any number of processing cores or may include any number of separate processors.

Memory controller 820 provides a communication path between processor 810 and other elements shown in FIG. 8. In some embodiments, memory controller 820 is part of a hub device that provides other functions as well. As shown in FIG. 8, memory controller 820 is coupled to processor(s) 810, I/O controller 840, and memory 830.

Memory 830 may include multiple serial I/O agents (e.g., FBDs) each associated with multiple memory devices. As described above with reference to FIGS. 1-7, the serial I/O agents may include multiple secondary ports. These memory devices may be based on any type of memory technology. For example, memory 830 may be random access memory (RAM), dynamic random access memory (DRAM), static random access memory (SRAM), nonvolatile memory such as FLASH memory, or nay other type of memory.

Memory 830 may represent a single memory device or a number of memory devices on one or more modules. Memory controller 820 provides data through interconnect 822 to memory 830 and receives data from memory 830 in response to read requests. Commands and/or addresses may be provided to memory 830 through interconnect 822 or through a different interconnect (not shown). Memory controller 830 may receive data to be stored in memory 830 from processor 810 or from another source. Memory controller 830 may provide the data it receives from memory 830 to processor 810 or to another destination. Interconnect 822 may be a bi-directional interconnect or a unidirectional interconnect. Interconnect 822 may include a number of parallel conductors. The signals may be differential or single ended. In some embodiments, interconnect 822 operates using a forwarded, multiphase clock scheme.

Memory controller 820 is also coupled to I/O controller 840 and provides a communications path between processor(s) 810 and I/O controller 840. I/O controller 840 includes circuitry for communicating with I/O circuits such as serial ports, parallel ports, universal serial bus (USB) ports and the like. As shown in FIG. 8, I/O controller 840 provides a communication path to RF circuits 850.

FIG. 9 is a bock diagram illustrating selected aspects of an electronic system according to an alternative embodiment of the invention. Electronic system 900 includes memory 830, I/O controller 840, RF circuits 850, and antenna 860, all of which are described above with reference to FIG. 8. Electronic system 900 also includes processor(s) 910 and memory controller 920. As shown in FIG. 9, memory controller 920 may be on the same die as processor(s) 910. Processor(s) 910 may be any type of processor as described above with reference to processor 810 (FIG. 8). Example systems represented by FIGS. 8 and 9 include desktop computers, laptop computers, servers, cellular phones, personal digital assistants, digital home systems, and the like.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description.

What is claimed is:

1. A serial input/output agent comprising:
a primary port to communicate data with an upstream agent over a serial point-to-point interconnect; and
M secondary ports to communicate data with a corresponding M downstream agents, wherein downstream data is forwarded from the primary port to at least one of the M secondary ports.

2. The serial input/output agent of claim 1, wherein the M secondary ports include:
a first secondary port coupled with the primary port to communicate with a first downstream agent; and
a second secondary port coupled with the primary port to communicate with a second downstream agent, wherein downstream data is forwarded from the primary port to at least one of the first secondary port and the second secondary port.

3. The serial input/output agent of claim 2, wherein the serial point-to-point interconnect includes a fully-buffered dual inline memory module channel.

4. The serial input/output agent of claim 2, wherein the first downstream agent and the second downstream agent are advanced memory buffers.

5. The serial input/output agent of claim 1, further comprising:
a tertiary port to communicate with a tertiary port of another agent, wherein the serial input/output agent and the other agent are at a same level in a hierarchy of agents.

6. The serial input/output agent of claim 1, wherein the M secondary ports are to concurrently communicate, respectively, with the M downstream agents.

7. The serial input/output agent of claim 6, wherein a link speed of the M secondary ports is substantially equal to 1/Mth of a link speed of the primary port.

8. The serial input/output agent of claim 1, wherein the serial input/output agent is an advanced memory buffer.

9. The serial input/output agent of claim 8, wherein the upstream agent is at least one of:
a memory controller; and
an upstream advanced memory buffer.

10. A method comprising:
receiving data at a primary port of a serial input/output agent, the primary port coupled with a serial point-to-point interconnect; and
forwarding the data to at least one of M secondary ports of the serial input/output agent, each of the M secondary ports to communicate data with a downstream agent.

11. The method of claim 10, wherein forwarding the data to one of the M secondary ports comprises:
forwarding a portion of the data to each of the M secondary ports, each of the M secondary ports to concurrently communicate a portion of the data to a downstream agent.

12. The method of claim 10, wherein the serial input/output interconnect is a fully-buffered dual inline memory channel.

13. The method of claim 12, wherein the serial input/output agent is an advanced memory buffer.

14. A system comprising:
a requesting agent to communicate data with a serial input/output agent; and
a first serial input/output agent coupled with the requesting agent via a point-to-point interconnect, the first serial input/output agent including a
a primary port to communicate data with the requesting agent over the point-to-point interconnect; and
M secondary ports to communicate data with a corresponding M downstream agents, wherein downstream data is forwarded from the primary port to at least one of the M secondary ports.

15. The system of claim 14, further comprising:
a second serial input/output agent coupled to one of the M secondary ports of the first serial input/output agent via the point-to-point interconnect, the second serial input/output agent including a
a primary port to communicate with the first serial input/output agent over the point-to-point interconnect, and
at least one secondary port to communicate data with a downstream agent, wherein downstream data is forwarded from the primary port to the at least one secondary port.

16. The system of claim 15, wherein the second serial input/output agent further comprises:
a tertiary port to communicate data with a third serial input/output agent, wherein the second serial input/output agent and the third serial input/output agent are at a same hierarchical level.

17. The system of claim 15, wherein
the system includes N serial input/output agents coupled together in a hierarchical tree configuration; and further wherein
access latency is substantially proportional to Log_{M}(N).

18. The system of claim 14, wherein
the first serial input/output agent is an advanced memory buffer and the point-to-point interconnect is a fully-buffered dual inline memory module channel.

19. The system of claim 18, further comprising:
a second serial input/output agent coupled to one of the secondary ports of the first serial input/output agent via the point-to-point interconnect, the second serial input/output agent including a
a primary port to communicate data with the first serial input/output agent over the point-to-point interconnect, and
a memory interface to communicate data with one or more memory devices.

20. The system of claim 19, wherein
the first serial input/output agent is located on a first partition of a circuit board and
the second serial input/output agent and the one or more memory devices are located on a second partition of the circuit board.

21. The system of claim 20, wherein the first partition of the circuit board supports a high-speed serial input/output interface and the second partition of the circuit board supports a double data rate interface.
